(19) United States
(12) Patent Application Publication
(10) Pub. No.: US 2003/0050045 A1
(43) Pub. Date: Mar. 13, 2003

(54) Wirelessly assisted contact information method

(76) Inventor: Peter J. Kennedy, Durham, NC (US)

Correspondence Address: COATS & BENNETT, PLLC, P O BOX 5, RALEIGH, NC, 27602, US

(21) Appl. No.: 09/952,937

(22) Filed: Sep. 12, 2001

(51) Int. Cl. H04M 11/10

(52) U.S. Cl. 455/412; 455/414

(57) ABSTRACT

A method for delivering contact information to consumers comprises sending contact information to an advertisement receiver and storing contact information therein. Upon user request, or automatically, the advertisement receiver forwards the contact information to the user's mobile terminal, such that the user may select the contact information and initiate contact therefrom through the mobile terminal.

### BACKGROUND OF THE INVENTION

The present invention relates to a method for assisting mobile terminals in securing contact information from an advertisement.

Radios and televisions broadcast many advertisements that include telephone numbers, uniform resource locators (URL), e-mail addresses, or the like, with which to contact an entity about the content of the advertisement. In most instances, the individual hearing and/or seeing the advertisement must hasten to grab a pad of paper and a writing instrument with which to scribble down the contact information. While phone numbers are relatively easy to capture in this fashion, the proliferation of toll free numbers, such as 800, 888, 866, 855, and 877, sometimes makes it difficult for an individual to capture properly the desired contact information. This situation is exacerbated with the addition of e-mail addresses and URLs, as such contact information frequently comprises backslashes, colons, and numerous other odd characters. Memory or transcription errors cut into the efficaciousness of the advertisements as people are unable to contact the advertisers. Further, users may transpose digits when dialing or introduce other errors that preclude the connection between the user and the entity behind the advertisement.

### BRIEF SUMMARY OF THE INVENTION

The present invention comprises a wireless technique by which contact information may be sent to a mobile terminal from which the user may then select the contact information and initiate contact. Specifically, concurrent with, or prior to, the broadcast of the advertisement with the contact information, a buffer associated with the advertisement receiver is filled with desired contact information. The contact information may then be sent to the mobile terminal wirelessly, such as through a Bluetooth module, from the advertisement receiver. A user may then use the mobile terminal to highlight or otherwise select the contact information and initiate contact through the mobile terminal with the person or source for which the contact information has been provided.

### BRIEF DESCRIPTION OF THE DRAWINGS

FIG. 1 illustrates a schematic drawing of an advertisement being broadcast from a broadcaster to an advertisement receiver;

FIG. 2 illustrates a schematic drawing of a broadcast receiver wirelessly communicating with a mobile terminal;

FIG. 3 illustrates a block diagram illustrating functional components of the advertisement receiver; and

FIG. 4 illustrates a flow chart demonstrating the steps associated with the present methodology.

### DETAILED DESCRIPTION OF THE INVENTION

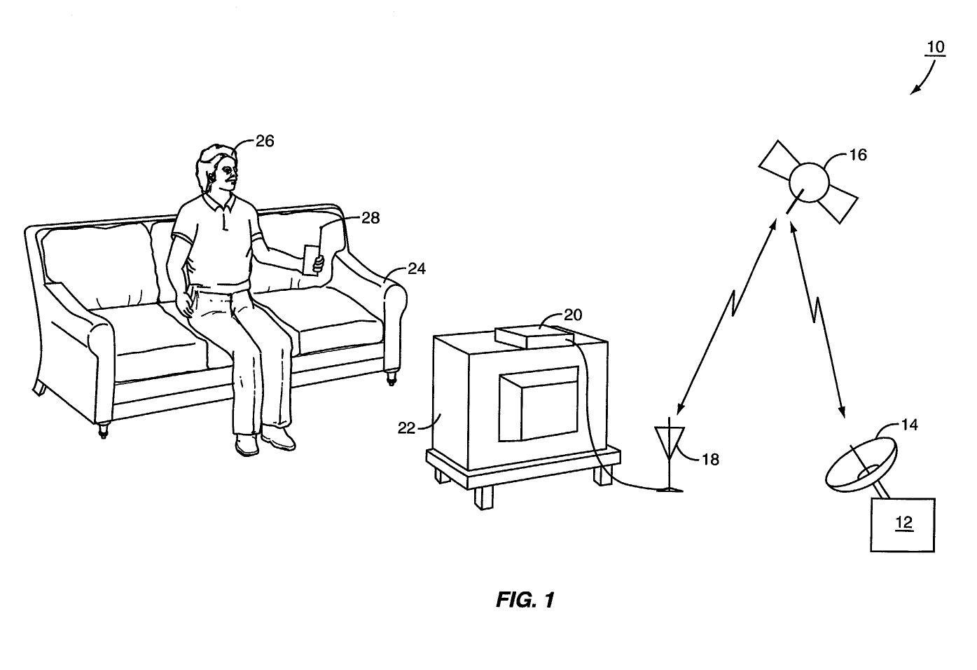

The present invention is adapted to convey contact information to a user's mobile terminal from an advertisement that the user may see and/or hear. For further explanation, reference is made to the drawings, specifically FIG. 1 where an exemplary broadcast system 10 comprises a broadcaster 12 and an advertisement receiver 20.

Broadcaster 12 comprises a broadcaster antenna 14 and, optionally, a satellite 16. Electromagnetic radiation, bearing a communication signal, is sent from broadcaster antenna 14 to receiver antenna 18, potentially through satellite 16 or via other conventional means. For example, receiver antenna 18 could be a pair of “rabbit ears” and broadcaster antenna 14 could be a conventional television or radio tower.

Receiver antenna 18 connects to advertisement receiver 20, which may be a conventional receiver designed to operate at a conventional frequency. A typical radio receiver would operate in the AM and FM bands. A conventional television antenna would operate in the UHF and VHF bands. Alternatively, a satellite antenna would operate according to the appropriate standards for such companies as the DISH NETWORK and DIRECT TV. Please note that the term “broadcast” as used herein includes over the air transmissions, cable transmissions, fiber optics transmissions, and the like. The term “broadcast” is used for convenience and is not intended to be limiting.

Advertisement receiver 20 may be secured to an entertainment device, such as television 22. Note that it is possible that advertisement receiver 20 is incorporated into the entertainment device without departing from the scope of the present invention. Further, in the exemplary embodiment, the entertainment device is a television 22; however, as noted above, in other embodiments, the entertainment device could comprise a radio with AM/FM reception capabilities or some other receiver.

In an exemplary embodiment, television 22 is positioned approximate couch 24, with user 26 sitting thereupon. User 26 may possess a mobile terminal 28. Mobile terminal 28 may comprise a cellular radiotelephone with or without a multi-line display; a Personal Communications System (PCS) terminal that may combine a cellular radiotelephone with data processing, facsimile and data communications capabilities; a Personal Digital Assistant (PDA) that may include a radiotelephone, pager, Internet/intranet access, Web browser, organizer, calendar and/or a global positioning system (GPS) receiver; and a conventional laptop and/or palmtop receiver or other appliance that includes a radiotelephone transceiver. Mobile terminals 28 may also be referred to as “pervasive computing” devices.

Mobile terminal 28 may use any number of conventional mobile terminal standards, such as TIA/EIA-136, Digital Advance Mobile Phone Service (D-AMPS), European Total Access Communication System (ETACS), Code Division Multiple Access (CDMA), Global System for Mobile Communication (GSM), Pacific Digital Cellular (PDC), and the like, the standards and documentation of which are herein incorporated by reference.

Against this backdrop of hardware, advertisement receiver 20 receives information from broadcaster 12, including advertisements that are output to the user 26 by audio and/or visual signals. Included in some or all of these advertisements may be contact information that is recited or displayed to the user 26. For example, a television advertisement may include a phone number displayed across the bottom of the screen of the television 22, along with verbal exhortations to the user 26 to make the phone call to contact the entity behind the advertisement currently being broadcast. As another example, a radio may verbally recite a phone number that an individual may wish to call to take advantage of a special promotion or deal associated with a particular advertisement.

The term “advertisement” as used herein includes conventional advertisements such as are commonly seen or heard on radios and televisions, as well as promotions such as are common on radios. For example, a typical radio station may include a promotion such as the ninth caller at 1-800-555-WERC will receive a free phone. While not a true advertisement per se, such a promotion fits within the definition of advertisement for the purpose of the present invention. The choice of the word “advertisement” is for convenience and is not intended to be strictly limiting.

In the past, if the user 26 wanted to use the contact information from the advertisement, the user 26 had to enter the phone number or other contact information manually into the mobile terminal 28. The present invention helps alleviate errors that may be introduced through manual error or the like. Likewise, the present invention may save time over the traditional methods of contact information entry.

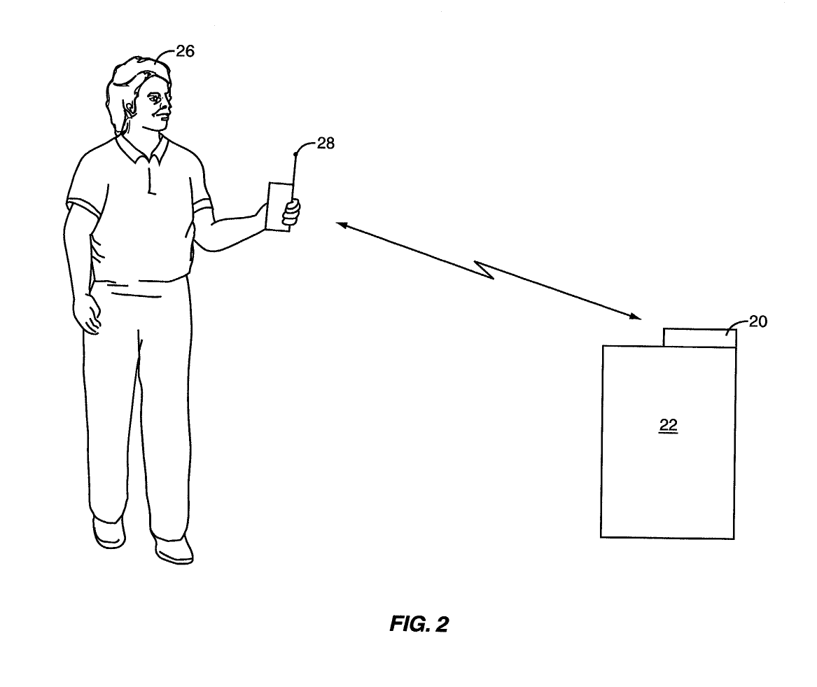

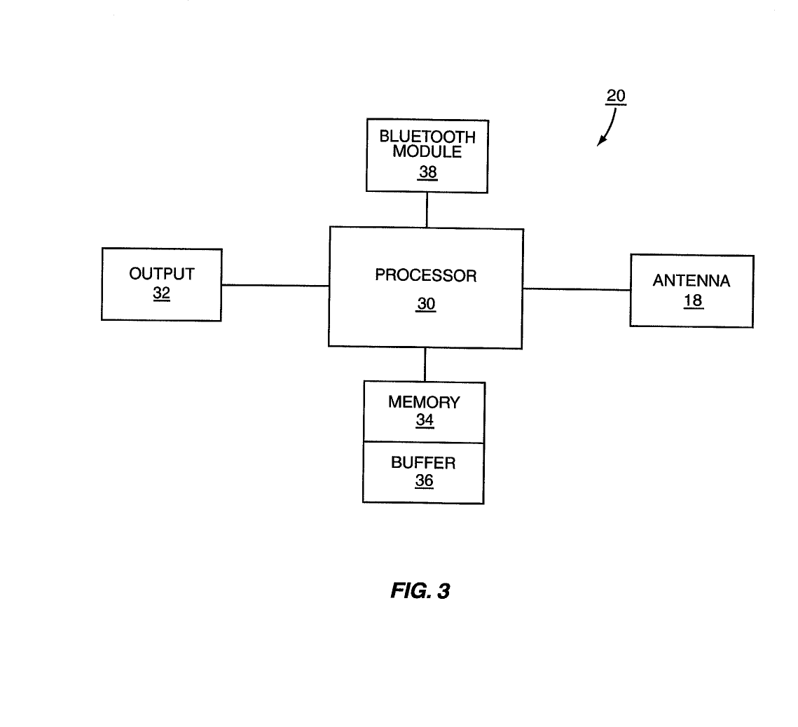

As illustrated in FIG. 2, advertisement receiver 20 may wirelessly communicate with mobile terminal 28 and pass along contact information to mobile terminal 28 such that user 26 may automatically initiate contact with the entity behind the advertisement. This is made possible through modifications to the advertisement receiver 20 as illustrated in FIG. 3. Specifically, advertisement receiver 20 may comprise a receiver antenna 18, a processor 30, output 32, memory 34 with buffer 36, and a Bluetooth module 38.

Processor 30 may be a microprocessor such as an INTEL PENTIUM 4 or the like and include a digital signal processor and other circuitry as is well understood to process signals coming in from receiver antenna 18.

Output 32 may comprise an output to a television screen, audio speakers, both, or the like. In an exemplary embodiment, output 32 is a cable that plugs into the back of a television 22 and conveys audio and video information to the television 22. Where the advertisement receiver 20 is incorporated into the entertainment device, output 32 may comprise the outputs of the entertainment device such as display, speakers, or the like.

Memory 34 may be RAM, a floppy disk, a R/W CD, EEPROM, or the like. Specifically, memory 34 includes a buffer 36 which selectively stores contact information received from broadcaster 12 and extracted from the normal broadcast signal.

Bluetooth module 38 may be a conventional Bluetooth module and is dictated by the appropriate Bluetooth standards, details of which may be found at www.bluetooth.com. Note that while Bluetooth technology is used, in the exemplary embodiment to effectuate the transfer of information from the advertisement receiver 20 to the mobile terminal 28, other wireless technology may also be used, including infrared, radio frequency, microwave, or the like.

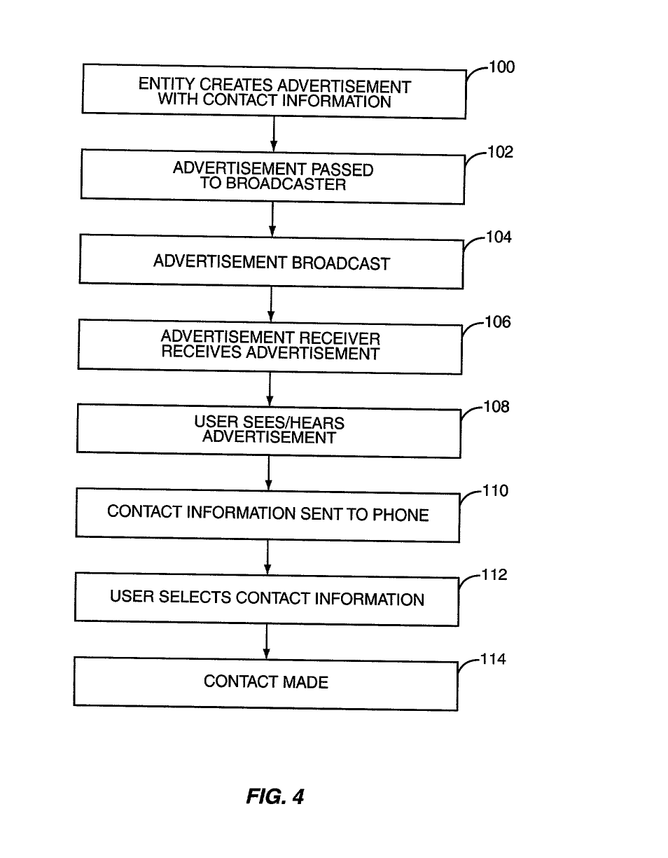

FIG. 4 illustrates the methodology of the present invention in flow chart format. Specifically, an entity creates an advertisement with contact information associated therewith (block 100). This entity may be an advertising agency, a business entity, or the like. Further, the term contact information as used herein includes telephone numbers, e-mail addresses, URLs, and the like. This advertisement is passed to a broadcaster (block 102). As noted elsewhere, the broadcaster may be a radio station, a television station, or the like, as is well understood.

At some point in the future, the advertisement is broadcast (block 104). As noted elsewhere, this broadcast may be over the air, through a satellite, over a cable or other wire-based medium, or the like, as needed or desired. The contact information may be concurrently broadcast with the advertisement through a number of conventional and unconventional mechanisms. In a television signal, the contact information may be broadcast in the retrace frame in a fashion comparable to closed captioning or second audio channels. In radio broadcast, vestigial sidebands may be used to contain the contact information. Alternatively, the contact information may be embedded into the signal proper through conventional encoding mechanisms.

Advertisement receiver 20 receives the advertisement through a conventional means (block 106) and extracts the contact information therefrom. In one embodiment, the contact information is extracted concurrently with the receipt of the advertisement and stored in buffer 36. In an alternate embodiment, the broadcaster may periodically send a look-up table comprising channels, times, advertisement indexes, and contact information. When an advertisement is received, the advertisement receiver 20 may reference the look-up table through an appropriate index and retrieve the appropriate contact information for storage in buffer 36. Alternatively, the contact information is retrieved only at the request of the user 26.

User 26 may see or hear the advertisement (block 108), depending on the nature of the advertisement and whether it is an audio and/or visual advertisement. User 26 may decide that the advertisement has piqued their interest and wishes to learn more about the subject matter of the advertisement.

The contact information is sent to the mobile terminal (block 110). In a first embodiment, user 26 actuates a command on the mobile terminal 28, which in turn actuates the Bluetooth module within the mobile terminal 28 so as to communicate with the Bluetooth module 38 within the advertisement receiver 20. The advertisement receiver 20 may then reference the look-up table and/or the buffer 36 to secure the contact information requested. The advertisement receiver 20 may then send the contact information to the mobile terminal 28 via the Bluetooth module 36 or other wireless communication link as is needed or desired.

Upon receipt of the information, thus user 26 may select the contact information (block 112) such as through a drop-down menu, an icon, or other conventional operating system command structure. After selection, contact may be made (block 114) between the user 26 and the entity that created the advertisement. From this contact, the user 26 may elicit more information from the entity, query the entity, or begin a sales transaction. As would be expected, the contact may be made through the appropriate contact information whether it be a phone number, e-mail address, URL, or other information provided.

In an alternate embodiment, the advertisement is not broadcast by a broadcaster 12 per se, but rather may be resident in a local transceiver positioned proximate a store, such as in a mall. Thus, when a user 26 walks past the advertisement receiver 20 in the mall, the user 26 may actuate the mobile terminal 28 to secure contact information from the store in the mall for later use.

In still another alternate embodiment, instead of user 26 actuated retrieval of the contact information from the advertisement receiver 20, the advertisement receiver 20 may push the contact information to the mobile terminal 28. Thus, as each advertisement was aired, or each advertisement receiver 20 was passed, the advertisement receiver 20 would initiate contact with the mobile terminal 28 and deliver the contact information thereto.

In still another alternate embodiment, the user 26 may select between automatic reception of contact information and user-instigated retrieval of contact information.

In yet another embodiment, closely related to the look-up table embodiment, a user 26 may request information about an advertisement that is not presently being aired on the entertainment device. Thus, for example, after an episode of MASH in which an automobile advertisement was aired, the user 26 could actuate a command on the mobile terminal 28 that references the look up table and extracts the contact information for the automobile advertisement. The user 26 may scroll through a menu or the like to find the appropriate advertisement, or may enter a time at which the advertisement was run, or other index mechanism as needed or desired so as to find the desired advertisement and contact information.

In general, mobile terminal 28 may be similar to a conventional mobile terminal but with modifications to software that allows the user 26 to receive, store, and select the contact information.

The present invention may, of course, be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A method of facilitating advertising, comprising:
wirelessly transferring contact information to a mobile terminal wherein said contact information is associated with an advertisement perceived by a user of said mobile terminal.

2. The method of claim 1 wherein wirelessly transferring contact information to a mobile terminal comprises wirelessly transferring contact information in response to a user request.

3. The method of claim 1 wherein wirelessly transferring contact information to a mobile terminal comprises automatically transferring contact information to the mobile terminal.

4. The method of claim 1 further comprising broadcasting the advertisement for the user to perceive.

5. The method of claim 4 further comprising broadcasting contact information in conjunction with said advertisement.

6. The method of claim 5 wherein broadcasting contact information in conjunction with said advertisement comprises concurrently broadcasting contact information with the advertisement.

7. The method of claim 5 wherein broadcasting contact information in conjunction with said advertisement comprises broadcasting a look up table with contact information for a plurality of advertisements.

8. The method of claim 1 wherein wirelessly transferring contact information to a mobile terminal comprises wireless transferring contact information with a Bluetooth module.

9. The method of claim 1 wherein said contact information is associated with a television advertisement perceived by a user of said mobile terminal.

10. The method of claim 1 wherein said contact information is associated with a radio advertisement perceived by a user of said mobile terminal.

11. A method of facilitating advertising, comprising:
forming a wireless communication link between a mobile terminal and an advertisement receiver; and
passing contact information to the mobile terminal from the advertisement receiver.

12. The method of claim 11 wherein passing contact information to the mobile terminal from the advertisement receiver comprises passing a phone number to the mobile terminal from the advertisement receiver.

13. The method of claim 11 wherein passing contact information to the mobile terminal from the advertisement receiver comprises passing a URL to the mobile terminal from the advertisement receiver.

14. The method of claim 11 wherein passing contact information to the mobile terminal from the advertisement receiver comprises passing an email address to the mobile terminal from the advertisement receiver.

15. The method of claim 11 further comprising associating the advertisement receiver with a television.

16. The method of claim 11 further comprising associating the advertisement receiver with a radio.

17. The method of claim 11 further comprising associating the advertisement receiver with a store in a mall.

18. The method of claim 11 further comprising broadcasting an advertisement from a broadcaster to the advertisement receiver.

19. The method of claim 18 further comprising conveying the advertisement to a user in possession of the mobile terminal in such a manner that the user may perceive the advertisement.

20. The method of claim 19 wherein passing contact information to the mobile terminal from the advertisement receiver comprises passing contact information in response to a user actuated command from the mobile terminal.

21. The method of claim 19 wherein passing contact information to the mobile terminal from the advertisement receiver comprises automatically passing contact information to the mobile terminal.

22. A method of communication, comprising:
wirelessly accepting contact information at a mobile terminal from an advertisement receiver;
displaying the contact information to a user; and
initiating contact to an entity with the contact information.

23. The method of claim 22 wherein wirelessly accepting contact information at a mobile terminal from an advertisement receiver comprises accepting contact information through a Bluetooth protocol.

24. The method of claim 22 further comprising accepting a user command to request contact information from the advertisement receiver.

25. The method of claim 22 wherein wirelessly accepting contact information at a mobile terminal from an advertisement receiver comprises automatically accepting contact information from the advertisement receiver.

26. The method of claim 22 wherein initiating contact to an entity with the contact information comprises dialing a phone number contained within the contact information.

27. The method of claim 22 wherein initiating contact to an entity with the contact information comprises directing a web browser to a URL contained within the contact information.

28. The method of claim 22 wherein initiating contact to an entity with the contact information comprises sending an email to an email address contained within the contact information.
